(19) United States
(12) Patent Application Publication
(10) Pub. No.: US 2026/0109104 A1
(43) Pub. Date: Apr. 23, 2026

(54) METHOD FOR ASSEMBLING AN ACOUSTIC PANEL USING A SHAPING TOOL

(71) Applicant: SAFRAN, PARIS (FR)

(72) Inventors: Nicolas Pierre LANFANT, MOISSY-CRAMAYEL (FR); Hugues Laurent ALGLAVE, MOISSY-CRAMAYEL (FR)

(21) Appl. No.: 19/487,824

(22) PCT Filed: May 20, 2024
(86) PCT No.: PCT/FR2024/050648

§ 371 Date: Nov. 25, 2025

(30) Foreign Application Priority Data
May 26, 2023 (FR) FR2305268

(51) Int. Cl. B29C 51/00; B29C 51/42; B29L 31/10

(52) U.S. Cl. CPC B29C 51/002; B29C 51/428; B29K 2715/003; B29L 2031/10

(57) ABSTRACT

A method for manufacturing an acoustic panel includes at least one multicellular body and an acoustic component, the method including positioning a blank made of thermoplastic material between a male portion and a female portion of a tool; shaping the blank into an acoustic component in a first bringing together of the male and female portions, so as to close the tool, disposing the multicellular body between the female portion of the tool and the acoustic component; and then a second bringing together of the male and female portions of the tool, so as to press the acoustic component against the multicellular body.

### TECHNICAL FIELD

The present invention relates to the general field of acoustic attenuation structures. More particularly, it relates to acoustic attenuation structures used to reduce the noise produced by airplane engines such as gas turbines or exhausts thereof.

### PRIOR ART

Acoustic attenuation panels typically consist of an acoustic surface plate or skin that is permeable to the acoustic waves that it is desired to attenuate, and a reflective solid plate or skin, referred to as a “closure plate or skin”, a multicellular body being disposed between these two skins. The multicellular body generally consists of a set of partitions, for example in the shape of a honeycomb, delimiting a plurality of cells. In a well-known manner, such panels form Helmholtz resonators which can attenuate acoustic waves in a certain frequency range. Acoustic attenuation panels of this type are described, in particular, in documents U.S. Pat. No. 5,912,442 and GB 2 314 526.

These acoustic attenuation panels are limited to simple cell shapes such as those of alveoli disposed in a NIDA® type honeycomb. Consequently, when it is desired to treat low frequencies, it is necessary to use thick multicellular bodies.

One solution for treating low frequencies without using an excessively thick multicellular body is to place hollow acoustic elements, for example open truncated cones, in the cells of the multicellular body as described in FR 3 082 987.

In order to manufacture such an acoustic panel, it is therefore necessary to assemble the acoustic skin with the hollow acoustic elements, the hollow acoustic elements with the multicellular body, and the multicellular body with the optional closure skin.

The various portions of the acoustic panel can be assembled by bonding.

However, each of these bonding operations requires an oven or autoclave step in order to ensure satisfactory attachment. As a result, many long and costly steps are required to assemble the acoustic panel.

The assembly of the acoustic component comprising the hollow acoustic elements is particularly delicate. More specifically, since the acoustic component is formed by stamping and then demoulding, it must be made from a thermoplastic material, the composition of which makes it easy to demould. However, a thermoplastic material with such demoulding properties has the disadvantage of being difficult to bond.

The assembly of the acoustic component can also be carried out by welding. However, the risk of deforming the hollow acoustic elements under the effect of the heat generated by welding is significant, whereas such deformation would lead to a deterioration in acoustic performance. The less fine and thinner the hollow acoustic elements, the greater the risk of deformation under the effect of heat.

### DISCLOSURE OF THE INVENTION

The aim of the present invention is to overcome the above-mentioned disadvantages by providing a solution for assembling the acoustic panel that allows satisfactory, rapid and inexpensive attachment.

To this end, a method is proposed for manufacturing an acoustic panel comprising at least one multicellular body and an acoustic component comprising a plurality of hollow acoustic elements having a shape progressively tapering between a base and an apex, said method comprising:
positioning a blank made of thermoplastic material between a male portion and a female portion of a thermoforming tool,
shaping said blank into an acoustic component by a first bringing together of the male and female portions of the thermoforming tool, so as to close said thermoforming tool, the thermoforming tool having a temperature greater than or equal to the glass transition or melting temperature of the thermoplastic material of the blank, then
cooling the thermoforming tool to a temperature less than the glass transition or melting temperature of the thermoplastic material of the acoustic component, then opening the thermoforming tool,
the method being characterised in that it further comprises:
disposing the multicellular body in the thermoforming tool while the acoustic component remains in contact with the male portion of the thermoforming tool, the multicellular body being disposed between the female portion of the thermoforming tool and the acoustic component, then
a second bringing together of the male and female portions of the thermoforming tool, so as to press the acoustic component against the multicellular body in order that the hollow acoustic elements of the acoustic component are disposed in the cells of the multicellular body, the male portion of the thermoforming tool having a temperature greater than the glass transition or melting temperature of the thermoplastic material or materials of the acoustic component at least in the contact areas between the acoustic component and the multicellular body.

Thus, by assembling the acoustic component with the multicellular body in the same tool as that used to manufacture said acoustic component, the number of steps required to manufacture the acoustic panel is greatly reduced. The risk of deforming the acoustic component during assembly is also reduced.

In addition, the presence of the multicellular body in the tool makes it easier to demould the hollow acoustic elements of the acoustic component and reduces the risk of damage or deformation of said acoustic elements during demoulding, by distributing the tensile force more evenly.

According to a particular embodiment of the invention, the multicellular body is made of thermoplastic material, and wherein, during the second bringing together of the male and female portions of the thermoforming tool, the male portion of said thermoforming tool has a temperature greater than the glass transition or melting temperature of the thermoplastic material or materials of the multicellular body, so that the acoustic component is welded to the multicellular body.

According to another particular embodiment of the invention, cross-linked adhesive is disposed on the surfaces of the multicellular body intended to be in contact with the acoustic component, before the second bringing together of the male and female portions of the thermoforming tool.

According to another particular embodiment of the invention, the pressure applied by the thermoforming tool is between 5 bar and 20 bar during the second bringing together of the male and female portions of the thermoforming tool.

Thus, the pressure applied is sufficient to enable satisfactory welding and/or bonding, without however exerting an excessively high pressure which could deform the multicellular body or the acoustic component.

In another particular embodiment of the invention, a metal plate is disposed between the female portion of the thermoforming tool and the multicellular body, before the second bringing together of male and female portions of the thermoforming tool.

Such a plate can distribute the forces exerted by the female portion of the thermoforming tool on the multicellular body.

According to another particular embodiment of the invention, during the second bringing together of the male and female portions of the thermoforming tool, the female portion of said thermoforming tool has a temperature less than the glass transition or melting temperature of the thermoplastic material or materials of the acoustic component and the multicellular body.

When the female portion is in direct contact with the multicellular body, or separated from the multicellular body by only the metal plate, it is preferable for its temperature to remain low in order to avoid undesirable deformation of the multicellular body.

According to another particular embodiment of the invention, a closure skin is disposed between the metal plate and the multicellular body before the second bringing together of the male and female portions of the thermoforming tool, in order that, during the second bringing together of the male and female portions of the thermoforming tool, the closure skin is pressed against the multicellular body so as to be assembled to said multicellular body.

When such a closure skin is disposed between the metal plate and the multicellular body, it is preferable for the temperature of the female portion of the tool to be greater than the glass transition or melting temperature of the closure skin, of the thermoplastic material or materials of the acoustic component and of the multicellular body.

It may therefore be advantageous to use a thermoforming tool with a high thermal reactivity, for example a thermoforming tool for which the temperature is controlled by pulsed air. More specifically, it is desired to enable rapid welding at the interfaces between the acoustic component and the multicellular body and between the multicellular body and the closure skin, while limiting the temperature rise in the core of the multicellular structure.

Thus, the acoustic component, the multicellular body and the closure skin, or an intermediate acoustic skin, can be assembled simultaneously.

According to a particular embodiment of the invention, the skin is made of thermoplastic material, and during the second bringing together of the male and female portions of the thermoforming tool, the female portion of the thermoforming tool has a temperature greater than the glass transition or melting temperature of the thermoplastic material or materials of the closure skin and the multicellular body, so that the closure skin can be welded to the multicellular body.

A rise in temperature of the female portion thus enables the skin to be welded to the multicellular body.

According to another particular embodiment of the invention, the multicellular body assembled at least with the acoustic component is demoulded from the thermoforming tool, and an opening acoustic skin is attached to the face of the acoustic component opposite the multicellular body.

According to another particular embodiment of the invention, the thermoforming tool is configured so that the distance between the male portion and the female portion of said thermoforming tool is not less than a given value.

This reduces the risk of excessive collapsing of the multicellular body during the bringing together of the male and female portions. For example, the thermoforming tool may comprise one or more spacers disposed between the female portion and the male portion and configured to maintain a minimum spacing distance between the female portion and the male portion. The spacer or spacers are disposed so as not to interfere with the arrangement of the multicellular body and the acoustic component inside the thermoforming tool. For example, the thermoforming tool may also comprise a control device configured so that the distance between the male portion and the female portion of said thermoforming tool is not less than a given value.

According to another particular mode of the invention, the male portion of the thermoforming tool is disposed below the female portion of said thermoforming tool with respect to the direction of gravity.

This configuration enables the multicellular body to be disposed in the thermoforming tool directly in contact with the acoustic component that remains in contact with the male portion of the tool. This avoids the risk of an offset between the acoustic component and the multicellular body, which could lead to damage to the parts or jamming of the thermoforming tool during the second bringing together.

### BRIEF DESCRIPTION OF THE DRAWINGS

FIG. 1 is a schematic exploded perspective view of an acoustic panel obtained by the method of the invention.

FIG. 2 is a schematic cross-sectional view of the acoustic panel of FIG. 1.

FIG. 3 is a schematic cross-sectional view of a thermoforming tool in the open position in which a blank is positioned.

FIG. 4 is a schematic cross-sectional view of the thermoforming tool of FIG. 3 in the closed position, having formed an acoustic component.

FIG. 5 is a schematic cross-sectional view of the thermoforming tool of FIGS. 3 and 4 in the open position, in which the acoustic component is in contact with the male portion.

FIG. 6 is a schematic cross-sectional view of the thermoforming tool of FIGS. 3 to 5 in the open position, in which a multicellular body is disposed.

FIG. 7 is a schematic cross-sectional view of the thermoforming tool of FIGS. 3 to 6 in the closed position so as to press the acoustic component against the multicellular body.

FIG. 8 is a schematic cross-sectional view of the thermoforming tool of FIGS. 3 to 5 in the open position, in which a multicellular body and a closure skin are disposed according to one variant.

FIG. 9 is a schematic cross-sectional view of the thermoforming tool of FIG. 8 in the closed position so as to press the acoustic component against the multicellular body and so as to press the closure skin against the multicellular body.

### DESCRIPTION OF THE EMBODIMENTS

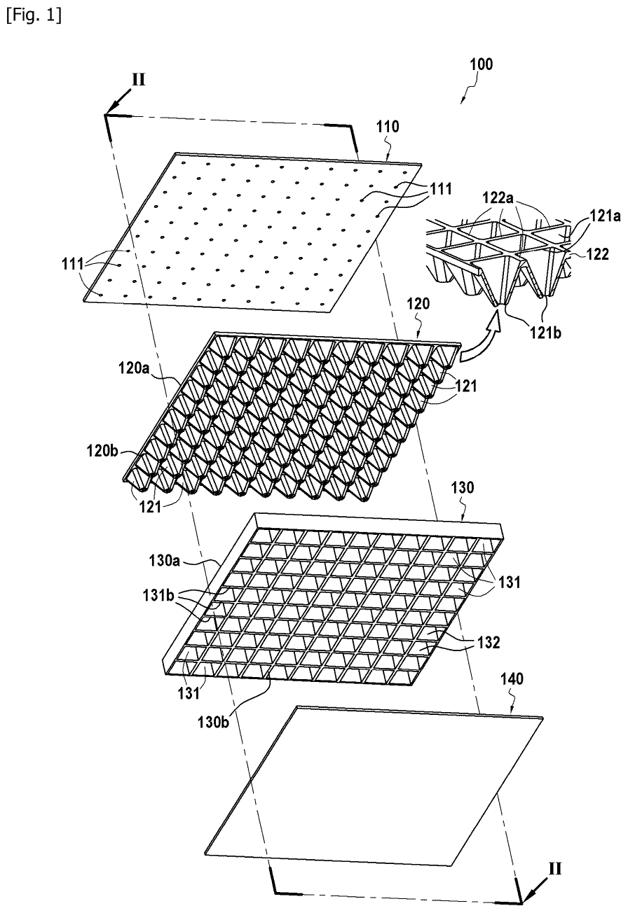

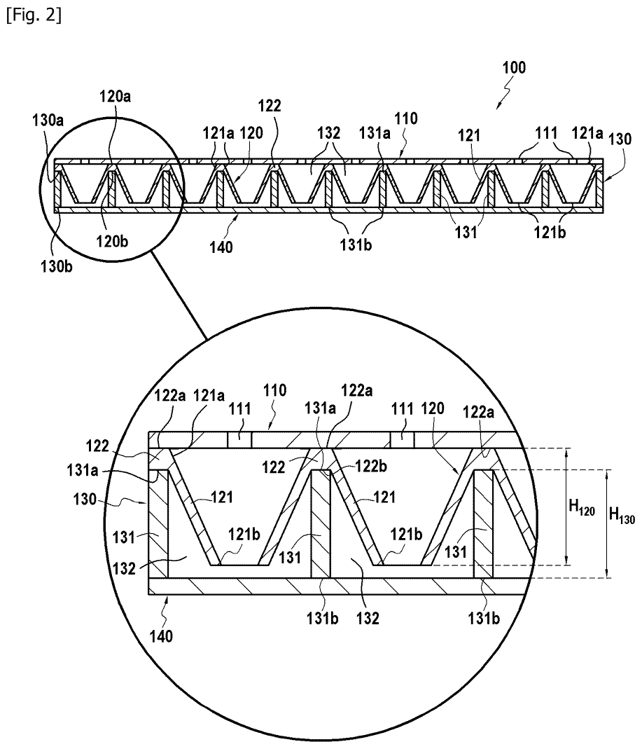

FIGS. 1 and 2 illustrate an example of an acoustic panel 100 comprising, in order, an opening acoustic skin 110, an acoustic component 120 comprising a plurality of hollow acoustic elements 121, a multicellular body 130 and a closure skin 140.

The function of the acoustic opening skin 110 is to allow the sound waves to be attenuated to pass into the interior of the acoustic panel 100. For this purpose, the opening acoustic skin 110 comprises a plurality of perforations 111, as illustrated in FIGS. 1 and 2. Each perforation 111 in the acoustic skin 110 preferably corresponds to a cell in the multicellular body 130 and to a hollow acoustic element 121 in the acoustic component 120. The acoustic opening skin 110 can be between 1 mm and 5 mm thick, for example 1.5 mm.

The acoustic opening skin 110 can be produced in a well-known manner by stamping, by automatic placing of fibres, known as “AFP” (Automated Fibre Placement), or by automatic draping of tape, known as “ATL” (Automated Tape Lying). Other methods can also be used to manufacture the acoustic opening skin 110, such as manual draping. The acoustic opening skin 110 can be made of a thermoplastic material, for example a composite material with a thermoplastic matrix comprising fibres. The fibres may be carbon, glass or aramid. The thermoplastic matrix can be made, for example, from polyaryletherketone (PAEK), polyetherketoneketone (PEKK), polyetherimide (PEI), polyphenylene sulfide (PPS), polyethersulfone (PESU) or polycarbonate (PC).

The closure skin 140 is a solid surface designed to reflect sound waves entering the acoustic panel 100. The closure skin 140 may be a component of the acoustic panel, as in the example described here, or may correspond to a structure of an object, for example an aircraft engine. In the latter case, the acoustic panel 100 has no closure skin and is mounted directly on the structure of the object.

The closure skin 140 can be produced in a well-known manner by stamping, by automatic placing of fibres, known as “AFP” (Automated Fibre Placement), or by automatic draping of tape, known as “ATL” (Automated Tape Lying). Other methods can also be used to manufacture the closure skin 140.

The closure skin 140 can be made of a composite material comprising fibres, for example a composite material based on carbon fibres impregnated with a thermoplastic or thermosetting resin. The closure skin 140 need not comprise any fibres. The closure skin 140 may comprise all the fibre types and all the matrix types described above for the acoustic opening skin 110. The acoustic skin of 140 may also comprise other types of fibre and other types of matrix than those described above.

The multicellular body 130 comprises a plurality of partitions 131 which form an array of ribs, thus delimiting cells 132. The partitions 131 each extend between a upper edge 131a and a lower edge 131b. The upper edges 131a of the partitions 131 define a first assembly face 130a of the multicellular body 130. The lower edges 131b of the partitions 131 define a second assembly face 130b of the multicellular body 130. The cells 132 thus extend from the first assembly face 130a to the second assembly face 130b of the multicellular body 130.

The heights H₁₃₀ of the cells 132 of the multicellular body 130 are chosen so as to obtain a treatment of the frequencies of interest, according to the use that will be made of the acoustic panel 100.

In the example shown in FIGS. 1 and 2, the cells 132 of the multicellular body 130 have a square cross-section. Of course, it does not depart from the scope of the invention if the cells 132 of the multicellular body 130 have a hexagonal, rectangular, round or other cross-section.

The multi-cellular body 130 can be made from a polymer, composite or metal material, by additive manufacturing or by conventional means. The multicellular body 130 can also be made in a well-known manner from thermoplastic material, by injection moulding, folding or tube assembly. The thermoplastic material can be filled with short fibres or long fibres. The multicellular body 130 need not be filled.

The acoustic component 120 comprises a plurality of hollow acoustic elements 121 each having a shape progressively tapering between a base 121a and an apex 121b. The hollow acoustic elements 121 are connected to one another by one or more connecting edges 122. The connecting edges 122 comprise an upper face 122a, located in the same plane as the bases 121a of the hollow acoustic elements 121, and a lower face 122b opposite the upper face 122a. The bases 121a of the hollow acoustic elements 121 and the upper faces 122a of the edges 122 define a first assembly face 120a of the acoustic component 120. The first assembly face 120a of the acoustic component 120 is intended to be assembled in contact with the acoustic skin 110. The lower faces 122b of the edges 122 define a second assembly face 120b of the acoustic component 120. The second assembly face 120b of the acoustic component 120 is intended to be assembled in contact with the multicellular body 130. More specifically, the second assembly face 120b of the acoustic component 120 is intended to be assembled in contact with the first assembly face 130a of the multicellular body 130.

In the example shown in FIGS. 1 and 2, the hollow acoustic elements 121 are pyramid-shaped. However, it does not depart from the scope of the invention if the hollow acoustic elements have a conical, spiral or funnel shape, for example. In the example shown in FIGS. 1 and 2, the hollow acoustic elements 121 are symmetrical. However, it does not depart from the scope of the invention if the hollow acoustic elements are asymmetrical.

The hollow acoustic elements 121 can have a wall thickness of between 0.25 mm and 2 mm. Preferably, the hollow acoustic elements 121 have a thickness less than 1 mm, for example between 0.3 mm and 0.5 mm. Preferably, the base 121a of the hollow acoustic elements 121 is included in a circle having a diameter of between 5 mm and 50 mm. For example, the base 121a of the hollow acoustic elements 121 is included in a circle having a diameter of 20 mm.

Preferably, the height H₁₂₀ of the hollow acoustic elements 121 is between 5 mm and 100 mm. For example, the height H₁₂₀ of the hollow acoustic elements 121 is 20 mm. The height H₁₂₀ of the hollow acoustic elements 121 is less than the height H₁₃₀ of the cells 132 of the multicellular body 130.

In the example shown in FIGS. 1 and 2, the acoustic panel 100 comprises only a single multicellular body and a single acoustic component. Of course, it does not depart from the scope of the invention if the acoustic panel comprises a plurality of superimposed multicellular bodies. It also does not depart from the scope of the invention if the acoustic panel comprises a plurality of acoustic components. The acoustic panel may also comprise intermediate acoustic skins delimiting different levels of the acoustic panel.

In accordance with the invention, the acoustic component 120 is produced by stamping.

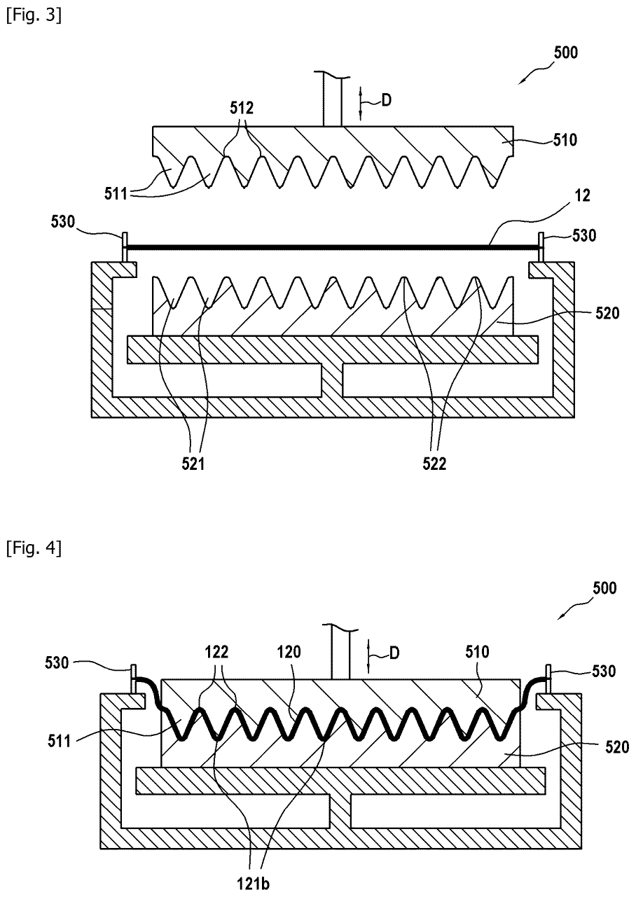

FIGS. 3 to 9 illustrate an example of a thermoforming tool 500 for shaping the acoustic component 120. The thermoforming tool 500 comprises a male portion 510 and a female portion 520 disposed opposite each other. The male portion 510 and the female portion 520 can be made of metal. In the example shown in FIG. 3, the female portion 520 of the thermoforming tool 500 is fixed relative to the frame of the thermoforming tool 500, while the male portion 510 of the thermoforming tool 500 is movable in a double direction D relative to the frame. The frame can comprise edge clamps 530 for holding the blank 12 of the acoustic component 120 between the male portion 510 and the female portion 520 of the thermoforming tool 500.

The female portion 520 of the thermoforming tool 500 comprises mould cavities 521 designed to cooperate with teeth 511 of the male portion 510 of the thermoforming tool 500. The mould cavities 521 and the teeth 511 have a shape corresponding to the shape of the hollow acoustic elements 121 of the acoustic component 120 to be produced.

The teeth 511 of the male portion 510 of the tool 500 are separated from each other by an array of recesses 512. The mould cavities 521 of the female portion 520 of the tool 500 are separated from each other by an array of protrusions 522. Thus, the array of recesses 512 on the male portion 510 is designed to cooperate with the array of protrusions 522 on the female portion 520. The array of recesses 512 in the male portion 510 and the array of protrusions 522 in the female portion 520 have a shape corresponding to the shape of the connecting edges 122 of the acoustic component 120 to be produced.

The temperature of the male 510 and female 520 portions can be controlled in a well-known manner. The temperature of the male 510 and female 520 portions can be controlled using an induction system, heat-transfer fluid channels or a pulsed-air system. The thermoforming tool 500 may also comprise auxiliary heating means enabling the blank 12 to be heated even when it is not in contact with the male 510 and female 520 portions.

As shown in FIG. 3, a blank 12 made of thermoplastic material is first disposed in the thermoforming tool 500 in the open position. The blank 12 is thus positioned between the male portion 510 and the female portion 520. The blank (12) can be held in place by edge clamps (530). The blank 12 is then exposed to a temperature less than the glass transition temperature, in the case of an amorphous material, or the melting temperature, in the case of a semi-crystalline material.

The blank 12 is then shaped into an acoustic component 120 by increasing the temperature to which the blank 12 is subjected. As shown in FIG. 4, the male portion 510 and the female portion 520 are brought together for the first time so that the thermoforming tool 500 is in the closed position. The male portion 510 and the female portion 520 are then brought into contact with the blank 12 so as to deform it into the acoustic component 120. When the thermoforming tool 500 is closed, the temperature of the male 510 and female 520 portions of the tool 500 is greater than or equal to the glass transition temperature, in the case of an amorphous material, or the melting temperature, in the case of a semi-crystalline material.

The tool 500 can be held in the closed position and maintained at a temperature greater than or equal to the glass transition temperature, in the case of an amorphous material, or the melting temperature, in the case of a semi-crystalline material, for a determined period of time.

Thus, the male 510 and female 520 portions of the tool 500 have a temperature less than the glass transition or melting temperature of the thermoplastic material when the blank 12 is positioned in said tool 500, then the temperature of the male 510 and female 520 portions of the tool 500 is increased until at least the glass transition or melting temperature is reached, the tool 500 being closed in order to shape the blank 12 when the glass transition or melting temperature is reached.

After shaping the acoustic component 120, the tool 500 is cooled to a temperature less than the glass transition or melting temperature of the thermoplastic material. The tool 500 is then opened by moving the male portion 510 away from the female portion 520. When the tool 500 is opened, the male 510 and female 520 portions are cooled.

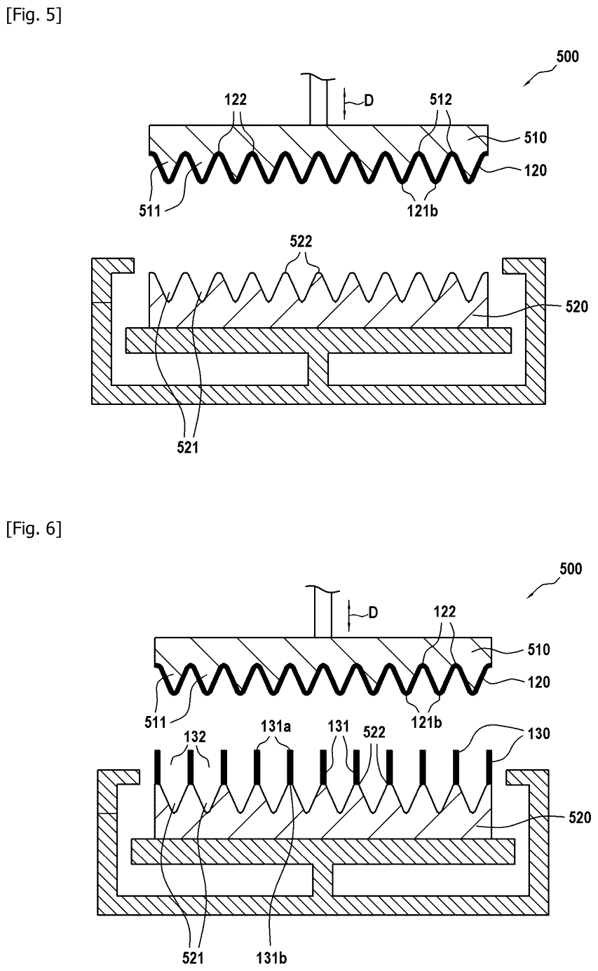

When the tool 500 is open, the acoustic component 120 remains in contact with the male portion 510 of said tool 500 due to differences in thermal expansion and contraction between the male portion 510 and the acoustic component 120, as illustrated in FIG. 5. The tool 500 can also be deliberately configured so that the acoustic component 120 remains in contact with the male portion 510 after said tool 500 has been opened.

The multicellular body 130 is then disposed in the thermoforming tool 500 in the open position, as shown in FIG. 6. The multicellular body 130 is thus disposed between the male portion 510 and the female portion 520, and more precisely between the acoustic component 120 and the female portion 520.

The multicellular body 130 is disposed in the thermoforming tool 500 such that the partitions 131 of said multicellular body 130 are positioned in the continuation of the array of protrusions 522 of the female portion 520, as illustrated in FIG. 6. The multicellular body 130 is disposed in the thermoforming tool 500 such that the partitions 131 of the multicellular body 130 are positioned opposite the recesses of the array of recesses 512 of the male portion 510.

In the example shown in the figures, the male portion is positioned above the female portion with respect to the direction of gravity. Of course, it does not depart from the scope of the invention if the male portion of the thermoforming tool is disposed below the female portion of said thermoforming tool with respect to the direction of gravity. This configuration is even advantageous in that the multicellular body can thus be positioned in the thermoforming tool directly in contact with the acoustic component which remains in contact with the male portion of the tool. This avoids the risk of an offset between the acoustic component and the multicellular body, which could lead to damage to the parts or jamming of the thermoforming tool during the second bringing together.

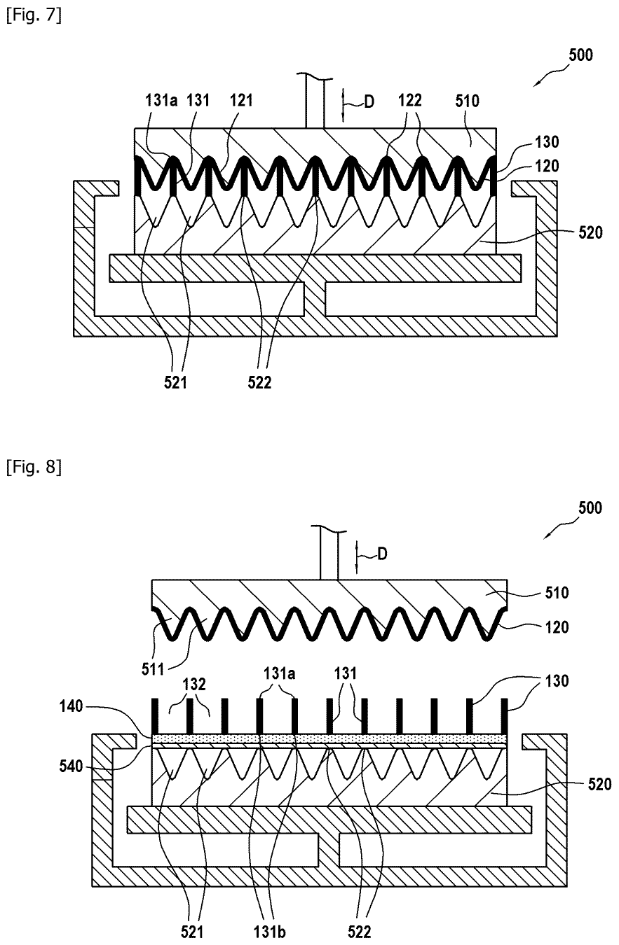

In a particular embodiment, a metal plate (not shown in FIGS. 6 and 7) can also be disposed in the open thermoforming tool 500. This metal plate is then disposed between the female portion 520 of the tool 500 and the multicellular body 130. When the male portion is disposed above the female portion with respect to the direction of gravity, the metal plate is then disposed in the open thermoforming tool 500 so that said metal plate is in contact with the female portion 520 of the tool 500 and in contact with the multicellular body 130. When the male portion is disposed below the female portion with respect to the direction of gravity, the metal plate is then disposed in the open thermoforming tool 500 such that said metal plate is in contact with the multicellular body 130. The use of such a plate distributes the closing forces of the tool 500 more evenly over the multicellular body 130.

When the multicellular body 130 is correctly disposed in the thermoforming tool, the male portion 510 and the female portion 520 are brought together for a second time, so that the acoustic component 120 is brought into contact with the multicellular body 130, as shown in FIG. 7. The thermoforming tool 500 is then in the semi-closed position. The pressure applied by the thermoforming tool 500 may be between 5 bar and 20 bar when the acoustic component 120 is brought into contact with the multicellular body 130.

Assembly of the acoustic component 120 with the multicellular component 130 can be achieved by welding. The multicellular body 130 is thus made of a thermoplastic material. At the time the multicellular body 130 and the acoustic component 120 are brought into contact, the male portion 510 of the tool 500 has a temperature greater than the glass transition or melting temperature of the thermoplastic material of the acoustic component 120 and of the multicellular body 130, at least in the contact areas between the acoustic component 120 and the multicellular body 130. The male portion 510 of the tool 500 may have a temperature greater than the glass transition or melting temperature of the thermoplastic material of the acoustic component 120 and the multicellular body 130 over its entire surface.

On the other hand, at the time the multicellular body 130 and the acoustic component 120 are brought into contact, the female portion 520 of the tool 500 has a temperature less than the glass transition or melting temperature of the thermoplastic material of the acoustic component 120 and the multicellular body 130. This ensures satisfactory welding of the multicellular body 130 to the acoustic component 120 while limiting the risk of deformation of the multicellular body 130. The holding of the acoustic component 120 against the multicellular body 130 lasts sufficiently long to allow the polymer chains to flow at the interface between the acoustic component 120 and the multicellular body 130. The length of time that the acoustic component 120 remains in contact with the multicellular body 130 is chosen according to the thermoplastic material or materials used. The contact time can be between one second and ten minutes.

Assembly of the acoustic component 120 with the multicellular component 130 can also be achieved by bonding. Cross-linked adhesive is then disposed on the upper edges 131a of the partitions 131 of the multicellular body 130 before it is disposed in the thermoforming tool 500. At the time the multicellular body 130 and the acoustic component 120 are brought into contact, the male portion 510 of the tool 500 has a temperature greater than the glass transition or melting temperature of the thermoplastic material of the acoustic component 120 and the multicellular body 130. On the other hand, at the time the multicellular body 130 and the acoustic component 120 are brought into contact, the female portion 520 of the tool 500 has a temperature less than the glass transition or melting temperature of the thermoplastic material of the acoustic component 120 and the multicellular body 130. This ensures satisfactory bonding of the multicellular body 130 to the acoustic component 120 while limiting the risk of deformation of the multicellular body 130.

The assembly of the acoustic component 120 with the multicellular component 130 can be achieved by simultaneous bonding and welding. The upper edges 131a of the partitions 131 can be activated by plasma treatment to facilitate welding or bonding, before the multicellular body 130 is disposed in the thermoforming tool 500.

The acoustic component 120 and the multicellular body 130 are then demoulded in order to obtain the desired assembly. The opening acoustic skin 110, or an intermediate acoustic skin, is then assembled with the acoustic component 120. The assembly of the opening acoustic skin 110 with the acoustic component 120 can be achieved by welding or bonding in a well-known manner. The multicellular body 130 is assembled with the closure skin 140, or with an intermediate acoustic skin. The assembly of the closure skin 140 with the multicellular body 130 can be achieved, for example, by welding or bonding in a well-known manner. The acoustic panel 100 is thus obtained.

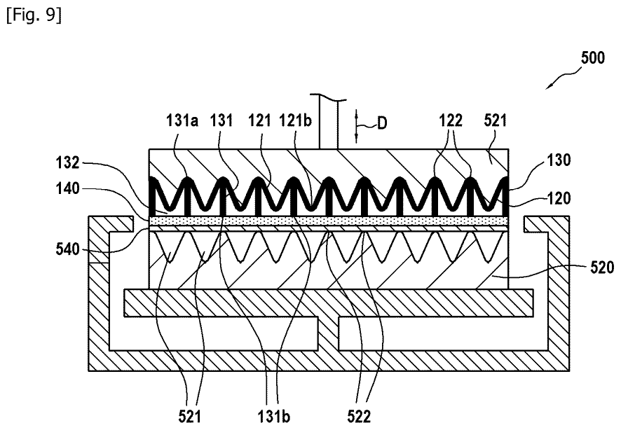

According to a variant illustrated in FIGS. 8 and 9, not only the multicellular body 130 but also the closure skin 140 are disposed in the open thermoforming tool 500 after the first bringing together. Thus, not only the assembly of the multicellular body 130 with the acoustic component 120 in the thermoforming tool 500, but also the simultaneous assembly of closure skin 140 with the multicellular body 130 are achieved.

As shown in FIG. 8, a metal plate 540 is disposed in the open thermoforming tool 500. Said metal plate 540 is then disposed between the female portion 520 of the tool 500 and the closure skin 140. When the male portion is disposed above the female portion with respect to the direction of gravity, the metal plate 540 is then disposed in the open thermoforming tool 500 such that said metal plate 540 is in contact with the female portion 520 of the tool 500 and in contact with the multicellular body 140. When the male portion is disposed below the female portion with respect to the direction of gravity, the metal plate 540 is then disposed in the open thermoforming tool 500 such that said metal plate 540 is in contact with the closure skin 140. The use of such a metal plate 540 can protect the closure skin 140 from the closing forces of the tool 500 and prevents it from deforming under the effect of the temperature of the tool 500.

The closure skin 140 is disposed in the open thermoforming tool 500. Said closure skin 140 is then disposed between the metal plate 540 and the multicellular body 130. The closure skin 140 is then disposed in the open thermoforming tool 500 such that said closure skin 140 is in contact with the metal plate 540 and in contact with the multicellular body 130.

When the multicellular body 130, the closure skin 140 and the metal plate 540 are suitably disposed in the thermoforming tool 500, a second bringing together is carried out between the male portion 510 and the female portion 520, so as to bring the acoustic component 120 into contact with the multicellular body 130 and to bring the multicellular body 130 into pressed contact with the closure skin 140, as illustrated in FIG. 9. The thermoforming tool 500 is then in the semi-closed position. The pressure applied by the thermoforming tool 500 may be between 5 bar and 20 bar when the acoustic component 120 is brought into contact with the multicellular body 130.

Assembly of the acoustic component 120 with the multicellular component 130 can be achieved by welding. The multicellular body 130 is thus made of a thermoplastic material. At the time the multicellular body 130 and the acoustic component 120 are brought into contact, the male portion 510 of the tool 500 has a temperature greater than the glass transition or melting temperature of the thermoplastic material of the acoustic component 120 and the multicellular body 130. Satisfactory welding of the multicellular body 130 to the acoustic component 120 is thus ensured. The holding of the acoustic component 120 against the multicellular body 130 lasts sufficiently long to allow the polymer chains to flow at the interface between the acoustic component 120 and the multicellular body 130. The length of time that the acoustic component 120 remains in contact with the multicellular body 130 is chosen according to the thermoplastic material or materials used. The contact time can be between one second and ten minutes.

Assembly of the acoustic component 120 with the multicellular component 130 can also be achieved by bonding. Cross-linked adhesive is then disposed on the upper edges 131a of the partitions 131 of the multicellular body 130 before it is disposed in the thermoforming tool 500. At the time the multicellular body 130 and the acoustic component 120 are brought into contact, the male portion 510 of the tool 500 has a temperature greater than the glass transition or melting temperature of the thermoplastic material of the acoustic component 120 and the multicellular body 130. Satisfactory bonding of the multicellular body 130 to the acoustic component 120 is thus ensured.

The assembly of the acoustic component 120 with the multicellular component 130 can be achieved by simultaneous bonding and welding. The upper edges 131a of the partitions 131 can be activated by plasma treatment to facilitate welding or bonding, before the multicellular body 130 is disposed in the thermoforming tool 500.

Assembly of the closure skin 140 with the multicellular component 130 can be achieved by welding. The multicellular body 130 and the closure skin 140 are then made of a thermoplastic material. At the time the multicellular body 130 and the acoustic component 120 are brought into contact, the female portion 520 of the tool 500 has a temperature greater than the glass transition or melting temperature of the thermoplastic material of the acoustic component 120 and the multicellular body 130. This high temperature of the female portion 520 of the tool 500 does not risk disturbing the welding and/or bonding of the acoustic component 120 to the multicellular body 130, because the female portion 520 is then separated from the acoustic component 120 by the closure plate 540, by the closure skin 140 and by the multicellular body 130. Satisfactory welding of the multicellular body 130 to the closure skin 140 is thus ensured. The pressed holding of the closure skin 140 against the multicellular body 130 lasts sufficiently long to enable the polymer chains to flow at the interface between the closure skin 140 and the multicellular body 130. The length of time that the closure skin 140 remains in contact with the multicellular body 130 is chosen according to the thermoplastic material or materials used. The contact time can be between one second and ten minutes.

Assembly of the closure skin 140 with the multicellular component 130 can also be achieved by bonding. Cross-linked adhesive is then disposed on the lower edges 131b of the partitions 131 of the multicellular body 130 before it is disposed in the thermoforming tool 500. At the time the multicellular body 130 and the acoustic component 120 are brought into contact, the female portion 520 of the tool 500 has a temperature greater than the glass transition or melting temperature of the thermoplastic material of the acoustic component 120 and closure skin 140. This high temperature of the female portion 520 of the tool 500 does not risk disturbing the welding and/or bonding of the acoustic component 120 to the multicellular body 130, because the female portion 520 is then separated from the acoustic component 120 by the closure plate 540, by the closure skin 140 and by the multicellular body 130. Satisfactory bonding of the multicellular body 130 to the closure skin 140 is thus ensured.

Assembly of the closure skin 140 with the multicellular component 130 can be achieved by simultaneous bonding and welding. The lower edges 131b of the partitions 131 can be activated by plasma treatment to facilitate welding or bonding, before the multicellular body 130 is disposed in the thermoforming tool 500.

The acoustic component 120, the multicellular body 130 and the closure skin 140 are then demoulded in order to obtain the desired assembly. The closure skin 140 assembled in this embodiment can also be an intermediate acoustic skin. The opening acoustic skin 110, or an intermediate acoustic skin, is then assembled with the acoustic component 120. The assembly of the opening acoustic skin 110 with the acoustic component 120 can be achieved by welding or bonding in a well-known manner. The acoustic panel 100 is thus obtained.

The acoustic panel 100 can be used, for example, for acoustic attenuation in an aircraft nacelle or engine, for a blade platform or for an aeronautical sleeve.

The expression “between . . . and . . . ” should be understood as including the limits.

1. A method of manufacturing an acoustic panel comprising at least one multicellular body and an acoustic component comprising a plurality of hollow acoustic elements having a shape progressively tapering between a base and an apex, said method comprising:
positioning a blank made of thermoplastic material between a male portion and a female portion of a thermoforming tool;
shaping said blank into an acoustic component by a first bringing together of the male and female portions of the thermoforming tool, so as to close said thermoforming tool, the thermoforming tool having a temperature greater than or equal to the glass transition or melting temperature of the thermoplastic material of the blank;
cooling the thermoforming tool to a temperature less than the glass transition or melting temperature of the thermoplastic material of the acoustic component then opening the thermoforming tool;
disposing the multicellular body in the thermoforming tool while the acoustic component remains in contact with the male portion of the thermoforming tool, the multicellular body being disposed between the female portion of the thermoforming tool and the acoustic component, then a second bringing together of the male and female portions of the thermoforming tool, so as to press the acoustic component against the multicellular body in order that the hollow acoustic elements of the acoustic component are disposed in the cells of the multicellular body, the male portion of the thermoforming tool having a temperature greater than the glass transition or melting temperature of the thermoplastic material or materials of the acoustic component at least in the contact areas between the acoustic component and the multicellular body.

2. The manufacturing method according to claim 1, wherein the multicellular body is made of thermoplastic material, and wherein, during the second bringing together of the male and female portions of the thermoforming tool, the male portion of said thermoforming tool has a temperature greater than the glass transition or melting temperature of the thermoplastic material or materials of the multicellular body, so that the acoustic component is welded to the multicellular body.

3. The manufacturing method according to claim 1, wherein cross-linked adhesive is disposed on the surfaces of the multicellular body intended to be in contact with the acoustic component before the second bringing together of the male and female portions of the thermoforming tool.

4. The manufacturing method according to claim 1, wherein the pressure applied by the thermoforming tool is between 5 bar and 20 bar during the second bringing together of the male and female portions of the thermoforming tool.

5. The manufacturing method according to claim 1, wherein a metal plate is disposed between the female portion of the thermoforming tool and the multicellular body before the second bringing together of the male and female portions of the thermoforming tool.

6. The manufacturing method according to claim 1, wherein, during the second bringing together of the male and female portions of the thermoforming tool, the female portion of said thermoforming tool has a temperature less than the glass transition or melting temperature of the thermoplastic material or materials of the acoustic component and of the multicellular body.

7. The manufacturing method according to claim 5, wherein a closure skin is disposed between the metal plate and the multicellular body before the second bringing together of the male and female portions of the thermoforming tool, in order that, during the second bringing together of the male and female portions of the thermoforming tool, the closure skin is pressed against the multicellular body so as to be assembled to said multicellular body.

8. The manufacturing method according to claim 7, wherein the closure skin is made of thermoplastic material, and wherein, during the second bringing together of the male and female portions of the tool, the female portion of the thermoforming tool has a temperature greater than the glass transition or melting temperature of the thermoplastic material or materials of the closure skin and of the multicellular body, so that the closure skin is welded to the multicellular body.

9. The manufacturing method according to claim 1, wherein the multicellular body assembled at least with the acoustic component is demoulded from the thermoforming tool, and wherein an opening acoustic skin is attached to the face of the acoustic component opposite the multicellular body.

10. The manufacturing method according to claim 1, wherein the thermoforming tool is configured so that the distance between the male portion and the female portion of said thermoforming tool is not less than a given value.

11. The manufacturing method according to claim 1, wherein the male portion of the thermoforming tool is disposed below the female portion of said thermoforming tool with respect to the direction of gravity.
